(19) United States
(12) Patent Application Publication
(10) Pub. No.: US 2007/0215269 A1
(43) Pub. Date: Sep. 20, 2007

(54) PROCESS AND MACHINE FOR FORMING AND HEAT-SEALING A PLASTIC FILM OVER AN ARTICLE SUCH AS A STERILE DISH FOR CULTURING MICRO-ORGANISMS, AND ARTICLE THUS OBTAINED

(75) Inventor: Michel Weil, Molsheim (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Etablissements STREB & WEIL, Duttlenheim (FR)

(21) Appl. No.: 11/679,503

(22) Filed: Feb. 27, 2007

(30) Foreign Application Priority Data
Mar. 7, 2006 (FR) 06 02022

(51) Int. Cl. B32B 37/00; B32B 38/04; B32B 38/00

(52) U.S. Cl. 156/229; 156/308.2; 156/308.4; 156/267; 156/522; 156/552; 156/583.1

(57) ABSTRACT

The article (10) comprises a central region (12) with a recessed rim (32) comprising a peripheral flat portion (14) onto which the film (40) is heat-sealed. The film used is a cold-drawable plastic film, and the process comprises in particular a step of peripheral holding and axial displacement of the film relative to the part, beyond the central region, by drawing the film in the region of the rim without any substantial external application of heat. The film is thus cold-formed to give it a concave shape with zones (42-48) associated with the central region (12) and the rim (32) of the article. The film is then held in contact with the flat portion, the whole being heated simultaneously to effect the heat-sealing.

The invention relates to the forming and heat-sealing of a plastic film over a flat article.

It relates more particularly to articles consisting of sterile dishes for culturing micro-organisms.

These sterile dishes, which are described for example in FR-A-2 819 523 and FR-A-2 833 608, take the form of a flat container closed off by a lid and adapted to contain a culture medium, typically a gelatinous medium. Dishes of this type, often called Petri dishes, are generally made of injection-moulded plastics. They are preferably transparent to allow visual inspection of the culture medium and, before they are used, to ensure that the medium is satisfactory: if sterility has not been maintained, germs will have developed on the culture medium and will be visible to the naked eye.

These dishes are not sealed per se, the lid being simply placed on the container. Consequently, before use, they have to be packaged in leaktight sterile manner to prevent any microbial contamination.

This packaging may be produced, in particular, as described in the two documents mentioned above, by means of a plastic film heat-sealed onto a flat portion of the periphery of the lid, thus enabling the dish to be hermetically sealed by enclosing the container without interfering with the transparency of the wall of the lid.

In practice, there is an offset in level in the axial direction between the bottom of the container and the periphery of the lid onto which the film is sealed. Because of this difference in level, once the product has been packaged, the film is not planar but assumes a frustum shape (in the case of a circular container) surrounding a flat central part. In other words, in order to wrap an article of this kind, the closure cover has to be made concave by deforming the film to give it a suitable non-planar shape.

Hitherto this operation has been carried out by thermoforming the film which has previously been coated with its adhesive layer. The next step comprises placing the cover thus formed in contact with the plastic article intended to receive it, then applying the heat-sealing heating tool, ensuring that the article and the shaped cover are properly aligned, and finally applying pressure so that the sealing agent of the adhesive layer of the film fuses with the plastics of the article.

This technique has the disadvantage of requiring two separate sets of tools, namely a thermoforming tool for giving the plastic film of the cover its concave shape, and a heat-sealing tool for welding the cover to the article.

The implementation of this technique also requires that a certain number of precautions be carried out, notably at the time of thermoforming, to avoid damaging the appearance and transparency of the film in its planar central part, so that later on the user can ensure, before using it for the first time, that the medium is indeed still sterile.

One of the objectives of the invention is to propose a technique by which, while ensuring a hermetic seal and sterility, it is possible to give the film a non-planar shape while overcoming the difficulties encountered in the prior art, by combining a thermoforming tool and a heat-sealing tool.

It will be noted that the invention is in no way limited to the packaging of dishes for culturing micro-organisms, or even to the packaging of dishes which are circular in shape, but may advantageously be applied to all kinds of articles closed off by a cover heat-sealed to a rim of the article, provided that there is an offset in levels between this rim, to which the cover is heat-sealed, and the central part of the article, covered by the cover.

The process of the invention is of the generally known type consisting of forming a plastic film and heat-sealing this film onto the periphery of an article which has, on the side covered by the film, a central region surrounded by a rim comprising a peripheral flat portion to which the film is heat-sealed, this flat portion being axially recessed relative to the plane of the central region, the process comprising the steps of previously shaping the film so as to give it a concave shape with zones associated with the central region and with the rim of the article, then heat-sealing the film onto the article, at least onto the region of the peripheral flat portion.

Characteristically of the invention, the film used is a cold-drawable plastic film and the process comprises the steps of:

a) placing the film in the non-drawn state over the central region of the article,

b) peripherally holding the film around the flat portion and axially moving the film relative to the part so as to bring the film closer to the central region until the film comes into contact with this central region,

c) continuing this axial movement beyond the central region while drawing the film in the region of the rim located between the central region and the peripheral flat portion, without any substantial external application of heat,

d) keeping the film in contact with the peripheral flat portion and simultaneously heating the film and flat portion to a temperature sufficient to cause them to be mutually bonded by heat-sealing, and

e) releasing the article covered with the heat-sealed film.

In other words, essentially, the invention proposes replacing the thermoforming of the earlier processes with a step of cold deformation under stress of a film which is normally not deformable. This cold forming is achieved by penetration under pressure of the article into the film, which is thus drawn. Then the heat sealing of the film on the article takes place. The two operations may be carried out at one and the same station, thus further increasing the production rate of the packaging line.

The implementation of the invention brings about a considerable number of advantages and in particular:
it retains the perfect transparency of the film, which is deformed cold and hence in a perfectly controllable manner,
to obtain perfect concentricity of the article which is to be packaged relative to the cover comprising the film preformed during the heat-sealing of these two parts, as the different operations are carried out during successive cycles carried out on one machine without transferring the parts,
because of the cold deformation, to obtain a pre-stretching of the cover which consequently holds the dish firmly closed by pressing the lid against the container,
to select a multilayer film of a different kind from the thermoformable films used previously, for example, to choose a PET/PE complex the sealing and transparency properties of which are superior to those of the monolayer thermoformable films currently used.

Highly advantageously, step d) also comprises heating the gap between the central region and the peripheral flat portion to a temperature sufficient to stretch the section of film extending freely in this gap.

If necessary, step e) is followed by a step of cutting the film around the article provided with the heat-sealed film.

The invention also proposes a machine for carrying out the process outlined above. Such a machine comprises, in a manner known per se, means for previously shaping the film into a concave form with zones associated with the central region and the rim of the article, and means for heat-sealing the film onto the article, at least over the region of the peripheral flat portion.

In a manner characteristic of the invention the machine has a single station comprising:

a) a support for the article,

b) means for placing the film, in the non-drawn state, over the central region of the article,

c) means for peripherally holding the film around the flat portion of the article in its support,

d) means for axially moving the film relative to the part, which are capable of bringing the film closer to the central region until the film comes into contact with this central region, then beyond the central region, while drawing the film in the region of the rim located between the central region and the peripheral flat portion, without any substantial external application of heat,

e) heat-sealing means, which are capable of holding the film in contact with the peripheral flat portion and simultaneously heat the film and flat portion to a temperature which is sufficient to bring about their mutual bonding by heat-sealing, and

f) means for freeing the article covered with the heat-sealed film from its support.

Highly advantageously, means are also provided for heating the gap between the central region and the peripheral flat portion to a temperature sufficient to stretch the section of film extending freely in this gap.

If necessary, means may be provided for cutting the film around the article provided with the heat-sealed film.

The invention also proposes, as a new product, an article of the type described hereinbefore, i.e. an article covered with a film which is heat-sealed at its periphery and having, on the side covered by the film, a central region surrounded by a rim comprising a peripheral flat portion onto which the film is sealed, this flat portion being axially recessed relative to the plane of the central region, and the film being a plastic film shaped so as to give it a concave form with zones associated with the central region and the rim of the article.

According to one feature of the invention, the material of the heat-sealed film is a cold-drawable plastic material.

The implementation of the invention makes it possible, in particular, as emphasised hereinbefore, to choose a non-heat-fusible plastic material for the film, notably a multilayer complex such as a PET/PE complex the sealing and transparency properties of which are superior to those of the monolayer thermoformable films currently used.

Highly advantageously, the section of film extending freely in the gap between the central region and the peripheral flat portion is a part which is under tension. In fact, the application of heat during heat-sealing not only melts the sealing agent but also eliminates any creases that may have formed in the film, particularly in the frustum-shaped part: the heat radiation of the sealing tool in fact makes it possible to release the stretching tensions from the film without affecting its transparency or its resistance and sealing properties.

The implementation of the process according to the invention will now be described in more detail with reference to the attached drawings, in which the same reference numerals have been used to denote identical elements from one Figure to another, and wherein:

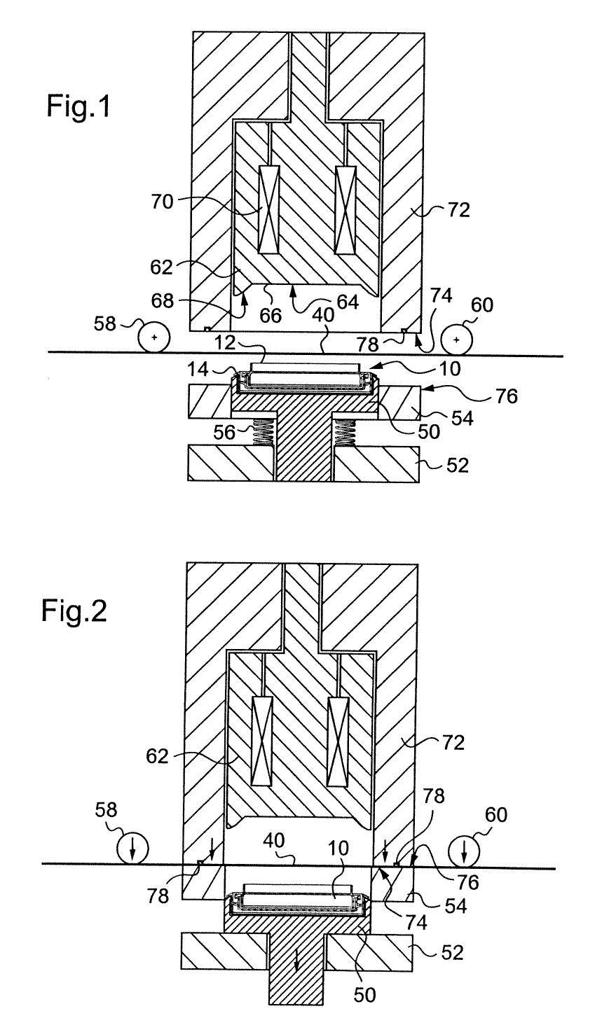

FIG. 1 shows the different elements as they are at the start of the cycle;

FIG. 2 shows the step of gripping the film;

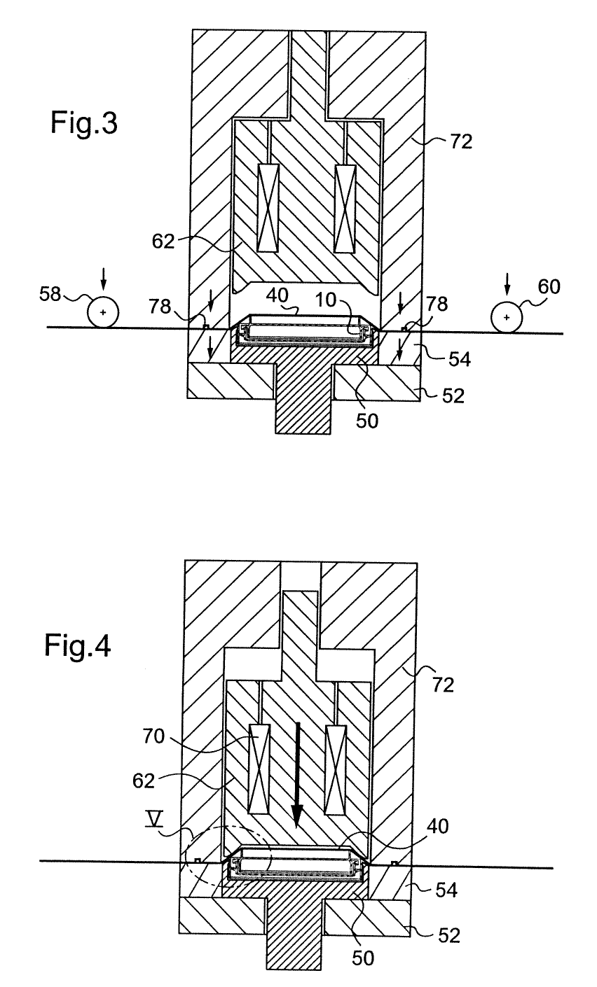

FIG. 3 shows the step of cold-drawing the film;

FIG. 4 shows the heat-sealing step;

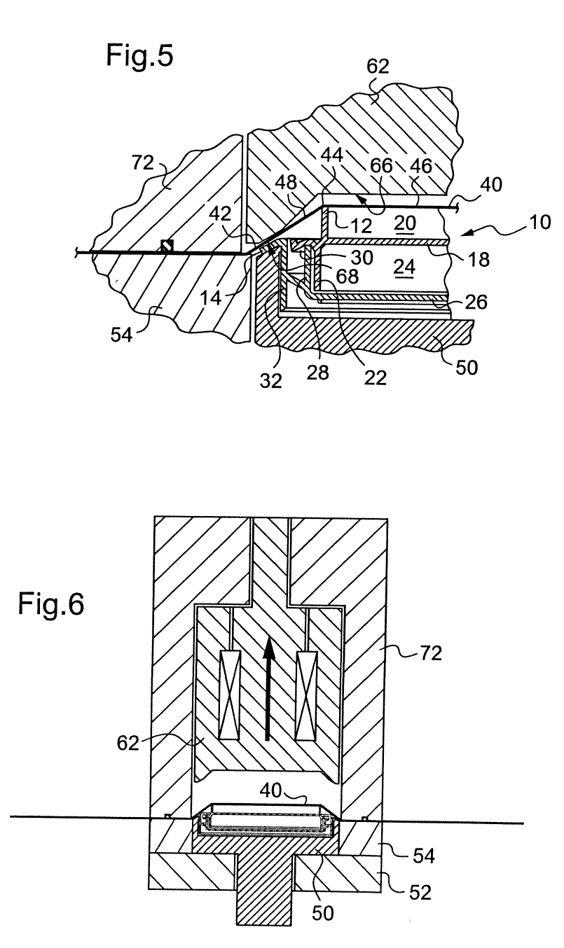

FIG. 5 is an enlarged partial view, corresponding to the detail marked V in FIG. 4;

FIG. 6 shows the step of cooling after sealing;

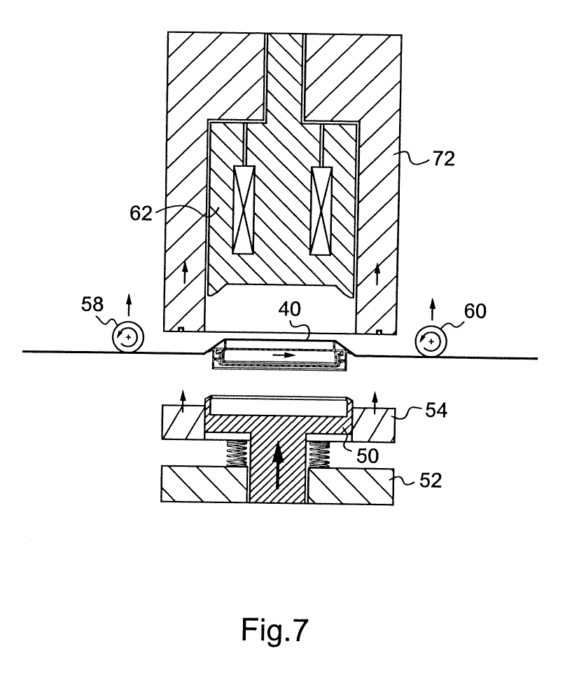

FIG. 7 shows the final step of opening up and removing the packaged article at the end of the cycle.

First of all, the article to be packaged will be described with reference to FIG. 1 and the enlarged view shown in FIG. 5.

In the embodiment shown, the article 10 is a sterile dish for culturing micro-organisms, of the Petri dish type, comprising a container closed off by a lid. This dish is shown in the inverted position, i.e. with the base of the container facing upwards and the lid facing downwards.

The base of the container comprises a peripheral cylindrical wall 12 defining a central region covered by a covering film sealed onto a peripheral flat portion 14 of the lid. In the invention, this peripheral flat portion 14 is axially recessed relative to the plane of the central region of the container. The container comprises a bottom wall 18 which defines with the cylindrical wall 12 a first volume 20 which can be left free, or used to accommodate, for example, a filter or any other accessory. The height of the cylindrical wall 12 may vary depending on the use. It may even be very small or absent if there is no need for a first volume 20 to be provided.

Opposite the cylindrical wall 12, the bottom wall 18 is extended by another cylindrical wall 22 defining a second volume 24 containing the gelatinised culture medium. The volume 24 is closed off by the central area 26 of the lid.

The lid is larger in diameter than the container and therefore extends beyond the latter all round, with in particular two concentric cylindrical side walls, specifically a first wall 28 bearing on the rim 30 of the container, and a second wall 32 extending laterally outwards via the flat portion 14. This flat portion 14 is preferably inclined relative to the radial plane, so as to assume a frustum shape corresponding roughly to a cone inscribed in the circle defined by the top of the cylindrical rim 12 of the container.

The packaging of this dish comprises applying to its front surface (bottom side, opposite the lid) a cover consisting of a film 40 attached to the lid by heat-sealing onto the peripheral flat portion 14.

Because the flat portion is recessed relative to the central area of the dish, once the film is in position it will bear at 44 on the top of the peripheral wall 12, which will have the effect of pressing the lid and container against each other, thus ensuring a leaktight and sterile closure until the cover is removed. The part 46 of the film located in the central region around the wall 12 is simply stretched, thus enabling the properties of transparency to be maintained at this location.

The configuration described above forces the film to have an inclined region 48 between the end of the wall 12 and the flat portion 14, in other words a concave configuration.

It is therefore necessary to give the film a non-planar shape beforehand while keeping it stretched tight, ensuring its seal and sterility and retaining the properties of transparency so that the user can be assured that the medium has remained sterile.

The invention proposes using for this film a multilayer film, for example a PET/PE complex provided with a heat-fusible sealing agent, this film being of a material which is normally not readily deformable, instead of and in place of the thermoformable films previously used which have inferior sealing and transparency properties. The film furthermore comprises on its surface a heat-fusible sealing agent, applied either to the entire surface of the film or only to a part of the film corresponding to the sealed part, i.e. the region of the flat portion 14.

The shaping operation is carried out cold, i.e. at a temperature around ambient temperature, using the machine which will now be described.

This machine comprises, below the length of film 40, a support 50 which receives the part which is to be packaged. This support is a retractable support which is movable axially downwards relative to a fixed bench 52. The retractable support 50 is also surrounded by a retractable blank holder 54 which is movable axially downwards. Springs 56 are interposed between the blank holder 54 and the fixed bench 52.

The length of film 40 is driven by rollers 58, 60 placed either side of the support 50. These rollers 58, 60 are also vertically movable in coordinated manner so as to lower the plane of the film 40 relative to the retractable support 50, as will be described below.

The machine also comprises, in the region above the film 40, a movable heated sealing head 62 having a concave lower surface 64, with a flat central part 66 and an inclined peripheral part terminating in a rim 68 of similar size and inclination to the flat portion 14 of the article 10. This sealing head is provided with heating means 70 such as electrical resistors or a system using a hot fluid.

The sealing head 62 is vertically movable relative to a support 72 which is itself vertically movable downwards, its lower surface 74 acting as a blank holder, similar to the upper surface 76 of the retractable blank holder 54 located below the film 40. The surface 74 carries a toroidal joint 78 adapted to ensure that the film is gripped as the surfaces 76 and 78 are brought together and to prevent any transverse slipping of the film along these surfaces.

The initial set-up of the machine is as shown in FIG. 1: above the film 40, the sealing head 62 and the support 72 are in a raised position, and above the film 40 the plastic part 12 has been placed on the support 50, ready to receive the film arranged above it so as to form the cover.

The next step, shown in FIG. 2, is a step comprising clamping the film 40 around the article 10, by simultaneously lowering the support 50, the movable support 72 and the rollers 58, 60 until the lower surface 74 of the support 72 comes into contact with the upper surface 76 of the retractable blank holder 54. The film is then clamped around its periphery by the toroidal joint 78 in the region located between these two surfaces 74 and 76.

The next step shown in FIG. 3, which is characteristic of the invention, consists in drawing the film while continuing to lower the movable support 72 onto the retractable blank holder 54. During this operation, the article 10 is held stationary by the support 50 which has been lowered onto the fixed bench 52 and it penetrates progressively into the film, the result of which is that the latter is drawn and shaped. The rollers 50 and 60 also move downwards in coordinated manner with the movable support 72.

This step is carried out at ambient temperature, i.e. without the application of external heat. It will be noted that, during this operation, the film remains clamped around the article 10, notably by the toroidal joint 78, thus allowing the drawing of the film while preventing any slipping thereof.

The next step, shown in FIG. 4, is a heat-sealing step which is carried out by lowering the movable sealing head 62 until the inclined peripheral surface 68 (FIG. 5) makes contact with the flat portion 14. By way of example, for an injection-moulded polystyrene article with a flat portion 14 that is 1 mm thick having diameters extending between 60 and 70 mm and for a PET/PE film 6 μm thick, the sealing parameters are: temperature 160 to 200° C., duration 1 to 2 seconds and sealing pressure 100 to 120 daN per cm².

It will be noted that the lower surface 66 of the sealing head 62 (FIG. 5) is configured so as to come into contact with the film and with the article only in the region of the flat portion 14, and that it is recessed in the other regions, notably the central region 46 and the region 48 that forms a continuation of the region 46 as far as the flat portion 14.

In particular, the (contactless) thermal heat radiation in this non-welded frustum-shaped region 48 can eliminate the tensions in the film produced locally in this region during the drawing and can “iron out” the creases which may have formed at this location during the cold deformation: in fact, the radiation locally releases the drawing tensions of the film without affecting its transparency and its resistance and sealing properties.

The next step, shown in FIG. 6, comprises raising the sealing head 62 so as to cool the film. If the latter is cooled naturally, it is then clamped for a typical period of the order of 2 to 4 seconds, but to increase production rates this time can be reduced by applying a cooling fluid.

The final step is shown in FIG. 7 and corresponds to the set-up at the end of the cycle, after the movable support 72 has been raised again and also the retractable blank holder 54 has been moved away to its travel end point.

The rollers 58 and 60 are also moved upwards, which has the effect of raising not only the strip of film but also the article which is attached to the film by the heat-sealing.

This movement is continued until the article is released from its support 50. The film is then advanced laterally, by rotation of the rollers 58, 60, until the packaged article is removed from the machine. The article is then separated by cutting the film around the heat-sealed flat portion, thereby forming a holding tab which makes it easier to peel off the cover at the time of use.

1. Process for forming a plastic film (40) and heat-sealing this film onto the periphery of an article (10) which has, on the side covered by the film, a central region (12) surrounded by a rim (32) comprising a peripheral flat portion (14) onto which the film is heat-sealed, this flat portion being axially recessed relative to the plane of the central region, the process comprising the steps of:
previously shaping the film so as to give it a concave shape with zones (42-48) associated with the central region (12) and with the rim (32) of the article, then
heat-sealing the film onto the article, at least onto the region of the peripheral flat portion,
characterised in that the film used is a cold-drawable plastic film and in that the process comprises the steps of:
a) placing the film in the non-drawn state over the central region of the article,
b) peripherally holding the film around the flat portion and axially moving the film relative to the part so as to bring the film closer to the central region until the film comes into contact with this central region,
c) continuing this axial movement beyond the central region while drawing the film in the region of the rim located between the central region and the peripheral flat portion, without any substantial external application of heat,
d) keeping the film in contact with the peripheral flat portion and simultaneously heating the film and flat portion to a temperature sufficient to cause them to be bonded to one another by heat-sealing, and
e) releasing the article covered with the heat-sealed film.

2. Process according to claim 1, characterised in that step d) also comprises heating the gap between the central region and the peripheral flat portion to a temperature sufficient to stretch the section of film (48) extending freely in this gap.

3. Process according to claim 1, characterised in that step e) is followed by a step of cutting the film around the article provided with the heat-sealed film.

4. Machine for forming a plastic film (40) and heat-sealing this film onto the periphery of an article (10) which has, on the side covered by the film, a central region (12) surrounded by a rim (32) comprising a peripheral flat portion (14) onto which the film is heat-sealed, this flat portion being axially recessed relative to the plane of the central region, this machine comprising:
means for previously shaping the film into a concave form with zones associated with the central region and with the rim of the article, and
means for heat-sealing the film onto the article, at least over the region of the peripheral flat portion,
said machine being characterised in that it has a single station comprising:
a) a support (50) for the article,
b) means (58, 60) for placing the film, in the non-drawn state, over the central region of the article,
c) means (54, 72) for peripherally holding the film around the flat portion of the article in its support,
d) means for axially moving the film relative to the part, which are capable of bringing the film closer to the central region until the film comes into contact with this central region, then beyond the central region, while drawing the film in the region of the rim located between the central region and the peripheral flat portion, without any substantial external application of heat,
e) heat-sealing means (62, 70), which are capable of holding the film in contact with the peripheral flat portion and simultaneously heat the film and flat portion to a temperature which is sufficient to bring about their mutual bonding by heat-sealing, and
f) means for freeing the article covered with the heat-sealed film from its support.

5. Machine according to claim 4, characterised in that it also comprises means for heating the gap between the central region and the peripheral flat portion to a temperature sufficient to stretch the section of film (48) extending freely in this gap.

6. Machine according to claim 4, characterised in that it also comprises means for cutting the film around the article provided with the heat-sealed film.

7. Article (10) covered with a film (40) which is heat-sealed at its periphery, this article having, on the side covered by the film, a central region (12) surrounded by a rim (32) comprising a peripheral flat portion (14) onto which the film is sealed, this flat portion being axially recessed relative to the plane of the central region, and the film being a plastic film shaped so as to give it a concave shape with zones (42-48) associated with the central region (12) and with the rim (32) of the article, said article being characterised in that the material of the film is a cold-drawable plastic material.

8. Article according to claim 7, characterised in that the material of the film is a non-heat-fusible plastic material.

9. Article according to claim 7, characterised in that the material of the film comprises a multilayer complex.

10. Article according to claim 9, characterised in that the material of the film comprises a PET/PE complex.

11. Article according to claim 7, characterised in that the section of film (48) extending freely in the gap between the central region (12) and the peripheral flat portion (14) is a part which is under tension.
